(19) United States
(12) Patent Application Publication
(10) Pub. No.: US 2009/0074908 A1
(43) Pub. Date: Mar. 19, 2009

(54) Crustacean bait

(75) Inventor: Ronald E. Rompala, Concord, NH (US)

Correspondence Address: BANNER & WITCOFF, LTD., TEN SOUTH WACKER DRIVE, SUITE 3000, CHICAGO, IL, 60606, US

(73) Assignee: Blue Seal Feeds, Inc., Londonderry, NH (US)

(21) Appl. No.: 12/200,622

(22) Filed: Aug. 28, 2008

Related U.S. Application Data
(60) Provisional application No. 60/973,278, filed on Sep. 18, 2007.

(51) Int. Cl. A23K 1/10; A23K 1/18; A23K 1/20

(52) U.S. Cl. 426/1

(57) ABSTRACT

Disclosed is a bait for lobsters and other crustaceans. The bait comprises fish meal, an alginate complex or carrageenan, at least one calcium compound, and fish hydrolyzate, said bait being attractive to a crustacean and being sufficiently durable for use as a bait to withstand submersion under 50° ocean water at a depth of at least ten feet.

### FIELD OF THE INVENTION

The invention relates to a bait for lobsters and other crustaceans.

### BACKGROUND OF THE INVENTION

Fishing for lobster has been a thriving industry in New England. Many lobstermen employ traditional methods established over 100 years ago. There have been some changes in traditional methods; for instance, metal traps have replaced those made from wood, and nylon bait bags are used rather than hooks. One traditional method that remains is using a quantity of fish, usually herring, as bait.

There have been attempts to use artificial baits. For an artificial bait to be effective, it should have three characteristics:
The bait should attract lobsters to a similar degree as fish bait
The bait should be durable and last in traps as long or longer than fish bait
The ingredients should not be toxic, should not leave a residue in the lobster, and should be biodegradable.

Although the factors that characterize the attractive nature of baits are not fully understood, it appears that chemical sensors on the lobster act to guide them to food. Certain nutrients have a higher ability to attract lobsters. It has further been reported that fish proteins attract lobster. However, certain amines from degrading proteins do not attract lobsters. For example, fresh fish attract lobsters better than those that were decomposing.

Currently there are two artificial baits that have been directed to attracting lobsters. Artificial baits produced from hides from cattle have been used to some extent. These baits hold up well over time on the ocean floor and have shown some ability to attract lobsters. However, hairs from baits produced from hides have shown up inside of dressed lobsters. For this reason the state of Maine has banned the use of unshaven hides as bait. In addition, lobstermen have not embraced the concept of using bait that does not originate from a marine source.

Another product is a circular disc made by a company called Popeye. This product is believed to hold up well on the ocean floor. However, this product has not been successful as an effective attractant. In addition, the product contains polyvinyl chloride. This product can be unappealing to environmentally conscious lobstermen.

### BRIEF SUMMARY

Aspects of the invention are directed to fish or crustacean bait comprising a combination of fish meal, an alginate complex or carrageenan, at least one calcium compound, and fish hydrolyzate in amounts effective to produce the fish or crustacean bait. Methods of fishing for lobsters and other crustaceans comprising employing such a bait are also within the purview of the invention.

Further aspects include a method of making fish or crustacean bait comprising mixing fish meal, an alginate complex or carrageenan, at least one calcium compound, and fish hydrolyzate in amounts effective to produce the fish or crustacean bait, molding the mixture, and placing the molded mixture into a salt bath.

### DETAILED DESCRIPTION

Although synthetic materials such as PVC may be employed in accordance with the present teachings, one aspect of the invention is directed to an all natural, essentially all-marine-derived, durable bait. In various embodiments, the bait is effective to attract lobsters, other crustaceans such as crabs, or fish. The bait is made from natural ingredients including ingredients found in marine environments. The bait is non-toxic, environmentally friendly, and holds up well in traps on the ocean floor. Further, the bait is readily and easily handled by lobstermen.

The bait contains an alginate complex or a carrageenan product. Alginate complexes, in particular, have a longer life than fresh herring or other types of fish bait. The alginate or carrageenan is combined with a calcium compound, such as calcium chloride. This combination produces a gelatinoid (gelled or gel-like) product via calcium linkages. The calcium and alginate or carrageenan product may be present in any amounts suitable to provide a gelatinoid bait.

The bait further contains an attractant. The attractant is used to attract lobsters and keep them from leaving the traps. In some embodiments, the attractant is a combination of fish meal and fish hydrolyzates. The fish hydrolysis is proteolyzed to form soluble pieces of protein. The fish meal may be any suitable fish meal. Herring meal may be employed, as may menhaden meal, a product which is similar to herring but less expensive.

Other ingredients may be employed. For instance, the bait may include a preservative. The preservative may be any suitable ingredient, such as potassium sorbate. The preservative may be present in any amount effective to provide a preservative function. The bait also may include a slow-release acidifier. This may be any product effective to release calcium slowly from the calcium compound, and, when used, should be used in an amount effective for this purpose. Suitable acidifiers include galacto-delta lactone (GDL) and lactide, a cyclic diester of lactic acid.

The bait may be made by mixing together all of the ingredients, molding by hand, and then placed in a salted water bath. Alternatively an extrusion or pelletizing device may be used where the bait would be mixed and then squirted out into the water bath. When the product is added to the salted water bath, it forms a gelatinoid form; subsequently, when removed from the water bath, the bait comes out harder and more rigid, like a rubber ball.

The product may take any suitable shape. For instance, the product may be provided in the form of circular discs, similar to a hockey puck.

In some embodiments, particularly when no preservative is employed in the product, the product is packed in salt to preserve the product. In many embodiments, the product will be viable for at least several weeks.

A lobster bait should be durable. In accordance with the present teachings, the bait may hold up for at least four days, and in some embodiments at least seven days, under 50° ocean water at a depth of at least 10 feet. This problem should be sufficiently durable to function as a bait for this period.

Any suitable amount of bait can be used in the trap. For example, each lobster trap will typically use about a half pound slug of lobster bait.

The formula contains effective amounts of each ingredient to obtain the desired bait. Typical ranges are as follows:

| | |
|---|---|
| Fish Meal | 20 to 28% |
| Alginate or Carrageenan | 2 to 6% |
| Calcium compound | 1 to 5% |
| Fish Hydrolyzate | 3 to 7% |
| Slow-release Acidifier (optional) | 1-5% |
| Preservative (optional) | 0.01-1.5% |
| Water | balance |

The following non-limiting Examples are provided to illustrate certain embodiments of the present invention.

### EXAMPLE 1

A bait having the following formula was prepared:

| | |
|---|---|
| Fish Meal (Special Select from Omega Proteins) | 24% |
| Sodium Alginate (400 from Tic Gums) | 4% |
| Calcium Carbonate | 2.7% |
| Fish Hydrolyzate (California Spray Dried) | 5.3% |
| Water | 64% |

The dry ingredients were combined in a mixing bowl. Water was added to the mixing bowl, and the ingredients were mixed for 1 minute, thus forming a dough. The dough was molded into a circular disc. The molded dough then was submerged in a water bath for 10 minutes, forming a gelatinoid product. The water bath was saturated with calcium chloride and acidified to a pH of 4 with acetic acid. After removal from the water bath, the product was allowed to drip dry for 10 minutes at room temperature. The product was then placed into a plastic storage contained with added salt at level of 20%

### EXAMPLE 2

Lobster bait was prepared as described above. A lobsterman fishing out of Rockland, Me. used 40 traps. Twenty traps contained the traditional herring chum and the other 20 traps contained the lobster bait. The results were 19 lobsters caught with herring and 16 lobsters caught with the bait. The bait was thus deemed comparable in efficacy to the herring.

### EXAMPLE 3

A bait having the following formulation was prepared:

| | |
|---|---|
| Fish Meal (Special Select from Omega Proteins) | 21.9% |
| Sodium Alginate (400 from Tic Gums) | 4.4% |
| Calcium Carbonate | 2.2% |
| Fish Hydrolyzate (California Spray Dried) | 2.2% |
| Potassium Sorbate | 0.9% |
| Galacto-Delta Lactone (GDL) | 2.8% |
| Water | 65.6% |

The dry ingredients without GDL were individually weighed and added to a mixing bowl. Water was added to the mixing bowl and the ingredients are mixed for 1 minute forming a dough. The GDL was added, and the formulation mixed an additional 1 minute. The dough was molded, submerged in a water bath, dried, and packaged without salt.

### EXAMPLE 4

A lobsterman that fished out of Rockland, Me. obtained the following results using the bait of Example 3. Herring also was employed as a control

| | | | Lobsters Caught | |
|---|---|---|---|---|
| Water Depth | Time in the Water | Traps | With Bait | With Herring |
| 30 fathoms | 5 nights | 25 | 39 | 80 |
| 10 fathoms | 8 nights | 46 | 33 | 48 |
| 10 fathoms | 8 nights | 70 | 20 | 45 |
| 10 fathoms | 7 nights | 20 | 11 | 6 |
| 10 fathoms | 7 nights | 24 | 13 | 5 |

It was observed that in some instances the bait of Example 3 performed better than herring.

It is thus seen that a lobster bait may be provided. It is contemplated that the bait may be suitable for other crustaceans or for fish.

In any listing of possible ingredients or components, mixtures of the possible ingredients or components are contemplated unless expressly indicated otherwise. The description of certain embodiments as “preferred” embodiments, and other recitation of embodiments, features, or ranges as being preferred, is not deemed to be limiting, and the invention is deemed to encompass embodiments that are presently deemed to be less preferred. All methods described herein can be performed in any suitable order unless otherwise indicated herein or otherwise clearly contradicted by context. The use of any and all examples, or exemplary language (e.g., “such as”) provided herein, is intended to illuminate the invention and does not pose a limitation on the scope of the invention unless otherwise claimed. Any statement herein as to the nature or benefits of the invention or of the preferred embodiments is not intended to be limiting, and the appended claims should not be deemed to be limited by such statements. More generally, no language in the specification should be construed as indicating any non-claimed element as being essential to the practice of the invention. This invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A bait comprising fish meal, an alginate complex or carrageenan, at least one calcium compound, and fish hydrolyzate, said bait being attractive to a crustacean and being sufficiently durable for use as a bait to withstand submersion under 50° ocean water at a depth of at least ten feet.

2. The bait of claim 1 comprising about 20 to about 28 wt % fish meal, about 2 to about 6 wt % alginate or carrageenan, about 1 to about 5 wt % calcium compound, and about 3 to about 7 wt % fish hydrolyzate.

3. The bait of claim 1 wherein the bait is a lobster bait.

4. The bait of claim 1 comprising an alginate complex.

5. The bait of claim 4 wherein the alginate complex is sodium alginate.

6. The bait of claim 1 wherein the calcium compound is calcium carbonate.

7. The bait of claim 1 comprising about 24 wt % fish meal; about 4% sodium alginate; about 2.7% calcium carbonate; and about 5.3 wt % fish hydrolyzate.

8. The bait of claim 1 wherein the bait is in the form of a circular-shaped disc.

9. The bait of claim 1, further including a slow-release acidifier.

10. A method of making bait comprising mixing fish meal, an alginate complex or carrageenan, at least one calcium compound, and fish hydrolyzate in amounts effective to produce the fish or crustacean bait, molding the mixture, and placing the molded mixture into a salt bath to produce a gelled product.

11. The method of claim 10 further comprising removing the gelled product from the salt bath.

12. The method of claim 10 further comprising packing the gelled product in salt for storage and transport.

13. The method of claim 10, comprising forming a circular-shaped disc.

14. The method of claim 10, comprising incorporating a slow release acidifier into the bait.
